(19) United States
(12) Patent Application Publication
(10) Pub. No.: US 2004/0167875 A1
(43) Pub. Date: Aug. 26, 2004

(54) Information processing method and system

(76) Inventor: Eriks Sneiders, Huddinge (SE)

Correspondence Address: Edward A. Pennington, Esq., Swidler Berlin Shereff Friedman, LLP, Suite 300, 3000 K Street, N.W., Washington, DC, 20007-5116, US

(21) Appl. No.: 10/368,452

(22) Filed: Feb. 20, 2003

(51) Int. Cl. G06F 7/00

(52) U.S. Cl. 707/3

(57) ABSTRACT

The present invention relates to processing of textual information in order to automatically answer user-submitted questions pertaining to a given knowledge domain. A proposed system (500) includes a user input interface (510) adapted to receive a user-formulated question (Q_{U}) on a natural language format. A transforming module (520), on one hand, converts the user formulated question (Q_{U}) into a question template format (Q_{UT}) including at least one entity term indicative of a respective main concept embodied in the user formulated question (Q_{U}), and on the other hand, converts the user formulated question (Q_{U}) into a data instance matching format (Q_{UD}) adapted to query a structured database (570), which represents at least a part of a conceptual model of the knowledge domain. A lexicon database (540) contains a multitude of concepts (C) which each is related to a specific question template. A template-matching engine (550) matches the question-template formatted user question (Q_{UT}) against the lexicon database (540) to retrieve a matching template cluster (C_{TQ}^{m}) associated with a matching query template (T_{Y}^{m}) and a matching answer template (α_{T}^{m}), and including at least one matching question template. This template, in turn, has at least one entity slot which is linked to the structured database (570). A data instance-matching engine (560) matches the data-instance-matching formatted user question (Q_{UD}) against the structured database (570) to identify at least one matching data instance (Dᵢ). A central processing unit (530) fills at least one particular entity slot of the at least one matching question template with the identified at least one matching data instance (Dᵢ). A search engine (580) queries the structured database (570) with the matching query template (T_{Y}^{m}) to retrieve information ([i]) to complete the matching answer template (α_{T}^{m}). A presentation interface (590) presents an answer (α) based on the retrieved information ([i]) and the matching answer template (α_{T}^{m}).

### THE BACKGROUND OF THE INVENTION AND PRIOR ART

The present invention relates generally to data processing in relation to information retrieval. More particularly the invention relates to a method of processing textual information to automatically answer user-submitted questions pertaining to a knowledge domain, a computer program product for performing this method, a computer readable medium containing such program and a textual information processing system.

Today's highly computerized industry and the generally increasing importance of efficient information processing and information retrieval procedures have placed an intensified focus on solutions for accomplishing an automated question answering. Normally, a user input interface which allows questions to be formulated in a natural language is here desirable because it requires a minimum of user effort. Moreover, such an interface is very intuitive, since it resembles an unconstrained person-to-person communication more than any alternative type of interface.

Various solutions are already known for answering natural-language questions by means of computer systems. For example, the U.S. Pat. No. 5,442,780 discloses a natural-language database retrieval system; wherein a parser parses received user queries into constituent phrases based on an analysis of the syntax of the queries. The parser uses tables and dictionaries to identify terms and to aid the grammatical syntax analysis. A collating unit then generates search instructions to a search engine for the database, so that an answer can be generated.

The published U.S. patent application No. 2002/0077931 discloses an automated decision advisor system for selecting products or services to users. The system dynamically selects those questions to ask that are most likely to help discriminate between items based on information about a particular user's preferences. The system scores available items in terms of how well they match the user's expressed needs, and explains its recommendations using lists of pros and cons to help the user understand how well a particular item matches his/her needs.

The U.S. Pat. No. 5,884,302 describes a database-processing system wherein the grammatical structure of a user-formulated question is analyzed. The question is then parsed into its grammatical components based on pre-defined grammatical rules. Subsequently, the components are transformed into instructions by means of pre-defined semantic rules. Then, a database is accessed in response to these instructions. Finally, an answer is generated based on the search result, and presented to the user. According to one embodiment, the natural-language question is compared with questions stored in the database. Each question in the database has its corresponding answer. If there is a match between a user's question and a stored question, the system retrieves the answer to the corresponding matched question and presents this answer to the user.

The International patent application No. WO00/57302 concerns a grammar template query system, wherein sources of information are determined on basis of a user input. A question processor here processes an initial user query to identify a set of correlated template questions selected from a question database. Each template question, in turn, is coupled to at least one answer reference. The question processor contains a parser for generating a syntactic structure from a list of words and a normalizer for reducing the syntactic structure to a canonical syntactic structure. If more than one template question is found, the user is prompted to select a particular template question. An answer processor then responds to the user-selected template question based on the at least one associated answer reference.

Hence, the prior art includes various examples of solutions for accomplishing natural-language-based question answering. However, all the earlier solutions are associated with more or less accuracy problems, for instance related to the interpretation of the user-formulated question.

### SUMMARY OF THE INVENTION

The object of the present invention is therefore to provide an improved solution for information retrieval based on natural language questioning, which alleviates the problems above and thus offers a comparatively fast, efficient and accurate processing.

According to one aspect of the invention the object is achieved by a method of processing textual information to automatically answer user-submitted questions pertaining to a given knowledge domain. The method includes the following steps. First, a user-formulated question is received on a natural language format. Then, the user-formulated question is represented on a question template format including at least one entity term indicative of a respective main concept embodied in the user formulated question. The user-formulated question is also represented on a data instance-matching format adapted to query a structured database. A template matching step matches the question-template formatted version of the user formulated question against a lexicon database to retrieve a matching template cluster including at least one matching question template. The lexicon database contains a multitude of concepts, which each is related to a specific question template. Then, it is tested whether at least one of the at least one matching question template includes at least one entity slot, which is linked to a structured database representing at least a part of a conceptual model of the knowledge domain. In any case, it is presumed that the matching template cluster is associated with an answer template. If this testing finds that at least one of the matching question templates has at least one entity slot, the matching template cluster is also associated with a matching query template. In this case, the following steps are also performed. The data instance-matching formatted user formulated question is data instance matched against the structured database to identify at least one matching data instance to fill at least one particular entity slot of the at least one matching question template. Additionally, the structured database is queried with the matching query template to obtain information completing the matching answer template. Finally, an answer is presented to be perceived by a user. This answer is based on the retrieved information and the matching answer template.

An important advantage attained by this method is that it allows the users to freely formulate their questions in natural language phrases, without having to compromise the relevance or the accuracy of the automatically generated answer.

According to a preferred embodiment of this aspect of the invention, if it is found that no matching question template includes any entity slots, the method includes the step of presenting an answer to be perceived by a user, which is based on static data in the matching answer template that is associated with the at least one matching question template. Thereby, for example, static FAQs may be handled.

According to another preferred embodiment of this aspect of the invention, before completing the querying step, the method involves the following steps. First, the at least one matching question template is presented to be perceived by a user, for instance in the form of a text on a display. The at least one matching question template is filled with the at least one matching data instance in at least one appropriate entity slot.

Thus, a number of alternative interpretations of the user-formulated question are presented. Then, the procedure waits until a user selection command is received in respect of one particular matching question template. Once such a command has been received, the selected question template is presumed to represent a preferred interpretation of the user formulated question, and producing the answer exclusively on basis of this interpretation. This strategy is advantageous, because it generally enhances the perceived quality of the answer, particularly if the knowledge domain per se is comparatively difficult to model conceptually, or the user-formulated question is semantically complex.

According to another preferred embodiment of this aspect of the invention, the lexicon database is a multiple-lexicon database which contains at least one autonomous unit. Each of the autonomous units is presumed to represent one or more concepts, which are related to one question template. Hence, a separate (and relatively small lexicon) is associated with each question template, such that the entire conceptual model is associated with a number of independent small lexicons. A multiple-lexicon database is desirable because thereby the user-formulated question may be separated into different question-specific knowledge domains. This in turn, renders it possible to draw distinct borderlines between relevant and irrelevant linguistic information with respect to the knowledge domain covered by the question templates. Furthermore, the autonomous units of the multiple-lexicon database may use common reusable components, thereby reducing any redundancy in the lexicon and accomplish an efficient processing.

According to still another preferred embodiment of this aspect of the invention, the data instance matching process involves searching in an index over data instances to produce a reduced set of candidate data instances. This is namely advantageous, since thereby the number of matching candidates may be reduced quickly, and the required total processing time may be held relatively short.

According to a preferred embodiment of this aspect of the invention, the data instance matching process involves an entity-specific matching of matching data instances which belong to at least one concept/entity. This procedure is desirable, for example when searching for person names having similar features, and a large number of person names are processed according to the same rules. Typically, another entity-specific lexicon is suitable when processing address information, and so on, because the linguistic information belonging to the data instances is here different.

According to a preferred embodiment of this aspect of the invention, the data instance matching process involves a data-instance-specific matching of matching alternative representations of data instances. For instance, pseudonyms and alternative names of cities. Naturally, this technique is desirable because it increases the possibilities of accomplishing an adequate interpretation of the user-formulated question.

According to a further aspect of the invention the object is achieved by a computer program product directly loadable into the internal memory of a computer, comprising software for performing the above proposed method when said program product is run on a computer.

According to another aspect of the invention the object is achieved by a computer readable medium, having a program recorded thereon, where the program is to make a computer perform the above-proposed method.

According to another aspect of the invention the object is achieved by a textual information processing system for automatically answering user-submitted questions pertaining to a knowledge domain. The system includes a user input interface, a transforming module, a central processing unit, a lexicon database, a structured database (which represents at least a part of a conceptual model of the knowledge domain), a template matching engine, a data instance matching engine, a query search engine and a presentation interface. The user input interface is adapted to receive a user-formulated question on a natural language format. The transforming module is adapted to, on one hand, convert the user formulated question into a question template format including at least one entity term indicative of a respective main concept embodied in the user formulated question. On the other hand, the transforming module is adapted to convert the user-formulated question into a data instance-matching format adapted to match data instances. The lexicon database contains a multitude of concepts, which each is related to a specific question template. The template matching engine is adapted to match the question-template formatted user formulated question against the lexicon database to retrieve a matching template cluster including at least one matching question template. The at least one matching question template, in turn, has at least one entity slot, which is linked to the structured database. The matching template cluster is associated both with a matching query template and a matching answer template. The data instance-matching engine is adapted to match the data instance-matching formatted version of the user-formulated question against the structured database to identify at least one matching data instance. The central processing unit is adapted to fill at least one particular entity slot of the at least one matching question template with the identified at least one matching data instance. The search engine is adapted to query the structured database with the matching query template to retrieve information to complete the matching answer template. The presentation interface is adapted to finally present this answer in such manner that it may be perceived by a human user, for example in the form of a text- or voice message.

This system is advantageous because it allows a user to freely formulate his/her question in the form of a natural language phrase, and at the same time receive an automatically generated answer which is highly relevant and accurate with respect to the question.

According to a preferred embodiment of this aspect of the invention, the presentation interface is adapted to present the at least one matching question template to be perceived by a user, and the user input interface awaits a user selection command in respect of one particular matching question template before triggering the search engine to query the structured database. Preferably, the answer is produced exclusively on basis of the selected matching question template. Thus, the selected matching question template represents a preferred interpretation of the user-formulated question. Of course, this is desirable because thereby the relevance of the answer is expected to increase further.

According to another preferred embodiment of this aspect of the invention, the lexicon database is a multiple-lexicon database containing at least one autonomous unit, which each represents one or more concepts being related to one question template. As mentioned above, a multiple-lexicon database is advantageous because it enables a distinction between irrelevant linguistic information with respect to the knowledge domain covered by the question templates. Moreover, the autonomous units of the multiple-lexicon database render it possible to reduce the redundancy in the lexicon and thereby accomplish an over-all efficient processing.

According to a preferred embodiment of this aspect of the invention, the data instance-matching engine is adapted to search an index over data instances, and thus produce a reduced set of candidate data instances. This is advantageous, since thereby the number of matching candidates may be reduced significantly by means of an initial index search. Subsequently, a more detailed search may be performed in respect of the reduced set. Consequently, the required total processing time may be held relatively short.

According to a preferred embodiment of this aspect of the invention, the data instance-matching engine is adapted to perform an entity-specific matching of matching data instances that belong to at least one concept/entity. This feature is desirable because it enables a searching being customized for a particular purpose depending on the structure of the linguistic information to be processed. For example, a first searching principle may be applied to person names, and a second searching principle may be applied to address information, and so on.

According to a preferred embodiment of this aspect of the invention, the data instance-matching engine is adapted to perform a data-instance-specific matching of alternative representations of data instances. Thereby, pseudonyms and alternative names of cities may also be searched efficiently.

Hence, the invention offers an excellent tool for querying customer databases and answering typical customer questions. Moreover, the proposed solution is highly customizable and independent from system architecture as well as the language processing techniques being used. The invention may therefore be adapted to a wide variety of applications.

### BRIEF DESCRIPTION OF THE DRAWINGS

The present invention is now to be explained more closely by means of preferred embodiments, which are disclosed as examples, and with reference to the attached drawings.

FIG. 1 outlines a general working principle of the invention,

FIG. 2 illustrates in further detail how textual information is processed according to an embodiment of the invention,

FIG. 3 shows a template-triplet according to an embodiment of the invention,

FIG. 4 shows a block diagram over a multiple-lexicon database according to an embodiment of the invention,

FIG. 5 shows a block diagram over a textual information processing system according to an embodiment of the invention, and

FIG. 6 illustrates, by means of a flow diagram, a general method for processing textual information according to the invention.

### DESCRIPTION OF PREFERRED EMBODIMENTS OF THE INVENTION

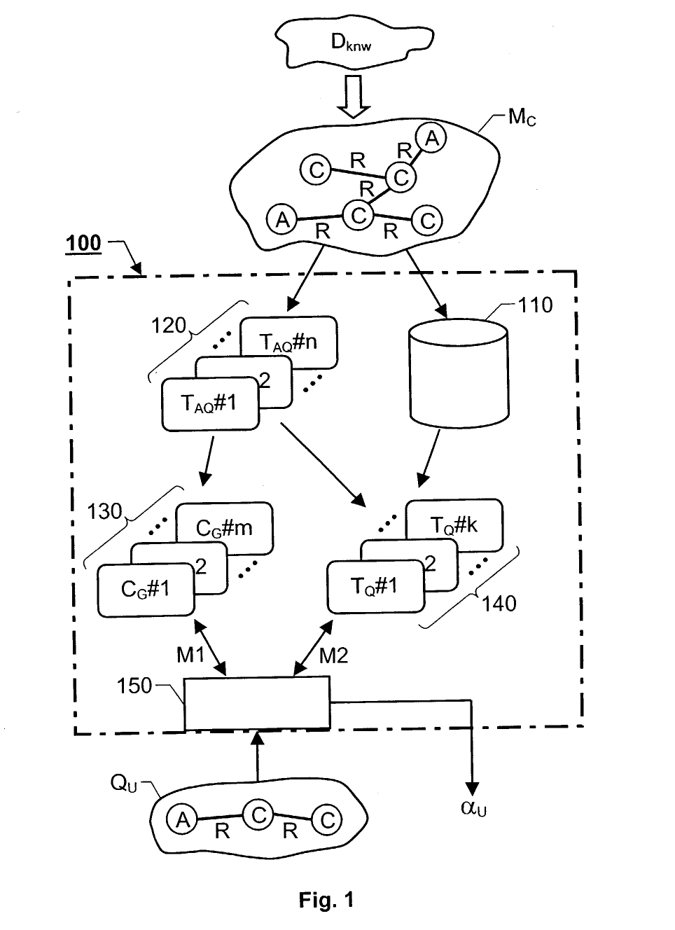

FIG. 1 outlines a general working principle of the invention according to which a question answering system 100 produces answers α_{U} to questions concerning a given knowledge domain D_{knw}. The knowledge domain D_{knw} is presumed to be modeled by a conceptual model M_{C}, wherein the knowledge is represented by concepts C, their relationships R to each other, and to so-called attributes A. For example, “Oliver Twist”, “Charles Dickens” and the word “author” may be concepts C, while the attributes A typically express adjectives or values, such as “green”, “great” or “gross”. The relations R simply indicate that there is a relationship between two or more entities, and possibly the strength of the relationship. The fundamentals of template-based question answering are matching the concepts C, attributes A and relationships R in a user question Q_{U} to their counterparts in the conceptual model M_{C} of the knowledge domain D_{knw}.

A database 110 may embody at least a part of the real world concepts C, their relationships R and their attributes A described in the conceptual model M_{C}. The conceptual model M_{C}, in turn, may be displayed graphically by means of entity-relationship (ER) diagrams or unified modeling language (UML) class diagrams. However, natural language sentences is an alternative way of displaying real world concepts C, their relationships R and their attributes A. So-called entity slots in a question template here represent the concepts C and their attributes A. The texts that link the entity slots represent the relationships R; either between different concepts C, between the concepts C and their attributes A, or between different attributes A.

Since the conceptual model M_{C} of a database and a question template deal with the same sort of objects, question templates may be mapped into the conceptual model M_{C}. This can be done by covering the conceptual model M_{C} with an exhaustive collection of question templates, such that entity slots in the question templates cover the concepts C or their attributes A in the conceptual model M_{C}, and the text in the question templates covers the relationships R or attributes A in the conceptual model M_{C}.

The question answering system 100 then matches a user question Q_{U} to the conceptual model M_{C} by means of a number of question templates 140 which cover the conceptual model M_{C}. A set of abstract question templates 120 may be created which contain concept slots representing either generic concepts 130 or specific data instances 140. The abstract question templates 120 express relationships R between different concept C slots or between concept C slots and their attributes A. Hence, the abstract question templates 120 mirror pieces of the conceptual model M_{C}. In a question answering system 100, the abstract question templates 120 may either be static in the form of FAQ-entries 130 or in the form of non-static question templates 140 having entity slots.

FAQ-entries 130 express questions about generic concepts. Each FAQ-entry C_{G}#1, C_{G}#2, . . . , C_{G}#m implies one or mores static relationships between different static concepts C or between static concepts C and their attributes A. In case the concepts C of the knowledge domain D_{knw} have relatively few data instances, it is preferable to cover the concept slots with generic concepts and produce an FAQ-database. Hence, for each new concept, relationship or attribute to be added to the database, a separate FAQ-entry is created. However, several concepts C, relationships R and attributes A may also be combined into a single FAQ-entry provided that the corresponding question remains intelligible.

Question templates having entity slots 140 express questions, about specific instances of concepts C. This type of template T_{Q}#1 T_{Q}#2, . . . , T_{Q}#k implies one or mores static relationships between different non-static concepts C or between non-static concepts C and their attributes A. Thus, an entity slot is a variable which embodies a variety of instances of a concept. The question templates T_{Q}#1, T_{Q}#2, . . . , T_{Q}#k having entity slots 140 are preferable to use in combination with a structured database 110 (e.g. a relational database) for knowledge domains D_{knw} where the concepts have comparatively many instances. Since each entity slot embodies a variety of data instances of a particular concept, one question template serves a large number of data instances which pertain to its entity slots. If, in this case, a new concept, relationship or attribute is to be added to the database 110, a new question template is created. However alternatively, the relationships and attributes may be transformed into meta-concepts. Nevertheless, each combination of relationships between the concept slots has its own question template.

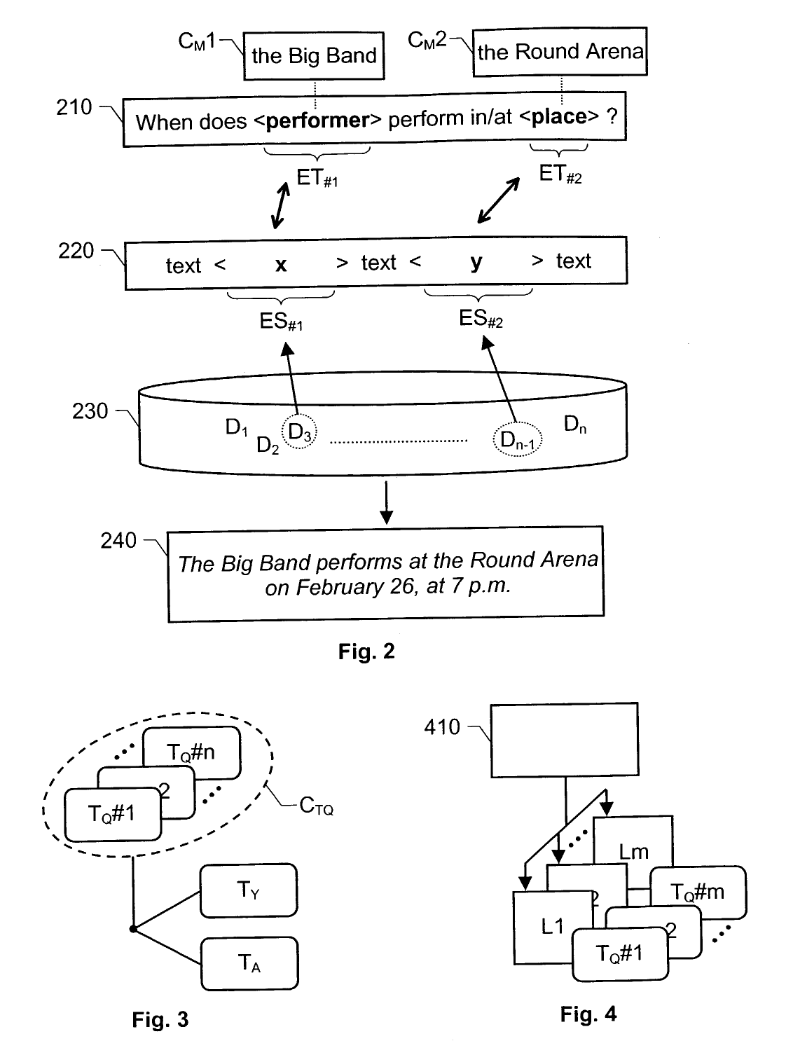

Further details pertaining to how textual information is processed, according to an embodiment of the invention, based on concepts and question templates having entity slots is illustrated in FIG. 2. Here, it is presumed that a natural language interface is used to receive user inquiries, i.e. questions. Data from a customer database 230 forms a basis for generating the corresponding answers. Specifically, query templates 220 are used to access the data in the database 230. These query templates 220 are customizable, so that they may make a best use of the particular data D₁, D₂, . . . , Dₙ in the database 230.

Moreover, each query template 220 is associated with an answer. Thereby, by retrieving at least one query template 220 that matches a user question (formatted as a question template 210), the answer to the question may be provided. The question-template model is advantageous because it does not depend on the architecture of the system nor does it depend on the language processing technique being used.

The proposed procedure will now be further elucidated with reference to an example. It is presumed that a user-submitted question is received saying: “When does the Big Band play at the Round Arena?”. In the received question two main concepts may be identified, namely a first main concept C_{M}1 relating to “the Big Band” and a second main concept C_{M}2 relating to “the Round Arena”. Such an identification is based on the presumption that the question template 210 is a parameterized question having user-specified entity terms, which in this example are two, i.e. a first user-specified entity term ET_{#1} representing “performer” and a second user-specified entity term ET_{#2} representing “place”.

Generally, in the process of answering a question, the user-specified entity terms ET_{#1} and ET_{#2} are replaced with data instances x and y from a customer database 230. In this example, if the first user-specified entity term ET_{#1} is filled with a first data instance in the form of “the Big Band” and the second user-specified entity term ET_{#2} is filled with a second data instance in the form of “the Round Arena”, we obtain a question-template representation of the user-submitted question saying: “When does the Big Band perform in/at the Round Arena?”, which is a specific expression of a question template 210 having the form “When does <performer> perform in/at <place>?”.

According to an embodiment of the invention, the question templates are grouped into clusters, where all templates in a particular cluster have the same entity slots, e.g. ES_{#1}=D₃ and ES_{#2}=Dₙ₋₁ respectively, and the same answer 240, e.g. “The Big Band performs at the Round Arena on February 26, at 7 p.m.”. The actual answer is created by means of a database query template 220, which preferably is a formal database query having a relevant number of entity slots for data instances, for example:

database_query(<ES_{#1}>, <ES_{#2}>)

and is executed against the customer database 230. The processing of a database query template returns raw data, e.g. D₃ and Dₙ₋₁, which normally needs to be formatted and complemented with wrapping text before being presented to a user. This is preferably accomplished by means of an answer template including a suitable wrapping text and at least one relevant entity slot, for example having the form: “<performer> performs there at <time>”.

FIG. 3 illustrates how a proposed template-triplet C_{TQ}-T_{Y}-T_{A} is formed. A number of question templates T_{Q}#1, T_{Q}#2, . . . , T_{Q}#n, say 1 to 3, having the same entity slots and the same answer are grouped together into a template cluster C_{TQ}. This cluster C_{TQ}, in turn, is associated with a particular query template T_{Y} adapted to query the database and a certain answer template T_{A} for producing an answer based on the data retrieved by means of the query template T_{Y}.

Each question template (see e.g. 140 in FIG. 1) is associated with a lexicon, which preferably is of so-called multiple-lexicon type. FIG. 4 shows a block diagram over a multiple-lexicon database according to an embodiment of the invention. The multiple-lexicon database contains at least one (usually many more) autonomous units (or lexicons) L1-Lm. Each of the autonomous units L1-Lm represents one or more concepts, say 5-10, which are all related to one question template T_{Q}#1-T_{Q}#m. Hence, L1 is associated with T_{Q}#1; L2 is associated with T_{Q}#2, and so on. A question template, such as T_{Q}#1, draws a distinct borderline between what is regarded as relevant and irrelevant linguistic information with respect to the given question template T_{Q}#1. Thus, a multiple-lexicon database is capable of drawing a comparatively accurate borderline between relevant and irrelevant linguistic information with respect to the entire knowledge domain covered by the question templates T_{Q}#1-T_{Q}#m which are included in the multiple-lexicon database. One advantage with the multiple-lexicon database is that the autonomous units L1-Lm may use common reusable components, organized in a shared unit 410. Thus, by means of the reusable components, any redundancies in the multiple-lexicon database may be reduced.

The proposed data instance matching process preferably involves an initial search in an index over data instances, so that a reduced set of candidate data instances may be produced. Naturally, such a reduction of the amount of data, may render a subsequent and more thorough matching process much faster. Hence, the initial index search generally reduces the required total processing time to complete a particular data instance matching.

As mentioned above, the fundamentals of template-based question answering is matching the objects and relationships in a user question to the concepts, their attributes and relationships in the conceptual model of the knowledge domain. In order to enable such a matching, the conceptual model is covered by a number of question templates. Hence, two important constituents of the proposed question-answering approach are (i) the user question and (ii) the question templates. The question templates express relationships between different entity slots (generic concepts or specific data instances), or between concepts and their attributes. The number of data instances of each concept determines the features of the entity slots, and subsequently the question templates.

The question submitted by the user is typically represented by a string of words, for example in the form of a written or spoken sentence. Of course, when producing this sentence, the user has an implied question in mind. In a given context, one submitted question may correspond to many different implied questions. For instance, a simple question saying: “What's up?” in the context of a database on the events in Stockholm may have two different meanings of which a first may be interpreted as “Hi, how are you doing?”, and a second as “What events take place in Stockholm this weekend?”. Therefore, many question templates may be required in order to cover a single expressed user question. As mentioned above, a set of question templates having the same answer are preferably grouped into a cluster. Each question template in a cluster thus represents an alternative form of a particular question. Thereby, one cluster may match one implied question.

Moreover, each cluster is associated with a particular answer template. The features of the answer template depend on what kind of concept slots that are used in the corresponding question template(s). If the answer template is associated with an FAQ-entry (i.e. typically a question template which includes only generic concepts) it represents a piece of static information, for example in the form of a text string (compare with 130 in the FIG. 1). However, an answer template being associated with a question template which has entity slots includes two components, namely a database query template and a layout template (compare with 110 and 140 respectively in the FIG. 1). The database query entry becomes an executable database query when its entity slots have been filled with relevant data instances. The layout template, which contains entity slots to be filled with data instances from the structured database, formats the output answer.

A template-matching technique determines whether or not a question in a question template and a user-submitted question have a common meaning, and if so, the level of similarity between them. According to the invention, any sentence matching or language processing technique may be used which is capable of determining a common meaning between different sentences and their level of similarity.

According to a preferred embodiment of the invention, the template-based question answering makes use of a multiple-lexicon database. Each question template here incorporates one unit of the multiple lexicon (i.e. the relationships L1-to-T_{Q}#1, L2-to-T_{Q}#2 etc. in FIG. 4). The proposed template matching technique uses the unit, say L1, when matching the question template T_{Q}#1 to a specific user question. The main duty of the unit L1 is to “decipher” the meaning of the user question and determine any match between the user question and the question template T_{Q}#1.

The multiple-lexicon matching approach may refine an application-specific knowledge domain by splitting the domain into two or more question-specific knowledge domains. Consequently, relationships between certain words which hold in the context of the application-specific knowledge domain need not be replicated in every unit of the multiple-lexicon database. The units L1-Lm share reusables for the lexicons.

A so-called data-instance matching technique is only used if the question templates have entity slots being linked to a structured database. According to the invention, this technique is not used for automated FAQ-answering. The data-instance matching technique matches relevant data instances which fill entity slots of question templates having been retrieved by the template matching technique. Preferably, the above-mentioned index searching strategy is used to quickly select relatively few candidate question templates for a subsequent and more thorough examination.

It should be noted that the model of template-based question answering does not specify the physical format of the customer database. This database may be a relational or an object-oriented database, or represent any other type or format provided that it has a conceptual model and is adapted to be queried by means formal queries. In fact, the data-instance matching technique may be a collection of techniques for matching diverse types of data instances to a user-submitted question. The proposed techniques have two levels of specificity; entity specific and data-instance specific, respectively

An entity-specific technique is applied to data instances which belong to one concept/entity, or a number of analogous concepts/entities. For example the entity-specific technique is suitable when different person names having similar features, and a large number of such person names are to be processed according to the same rule. The entity-specific techniques use entity-specific lexicons which contain linguistic information being specific for data instances that belong to a given entity. For instance, a type of linguistic information which is relevant for processing person names may not be relevant for processing addresses, and vice versa. Also the entity-specific lexicons share reusables.

Data-instance-specific techniques handle specific single-data instances. Preferably, these techniques are used to deal with alternative textual representations of data instances, such as pseudonyms, alternative names of cities and places etc. Also the data-instance-specific techniques use data-instance-specific lexicons and share reusables.

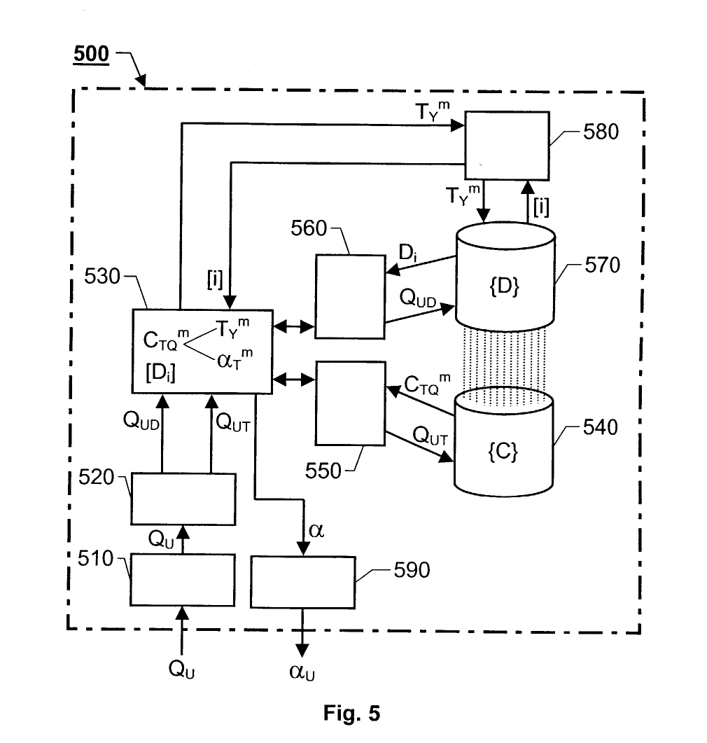

A textual information processing system 500 according to an embodiment of the invention will now be described with reference to a block diagram in FIG. 5.

The system 500 includes a user input interface 510, a transforming module 520, a central processing unit 530, a lexicon database 540 containing a multitude of concepts C which each is related to a specific question template, a structured database 570 representing a conceptual model of a knowledge domain, a template matching engine 550, a data instance matching engine 560, a search engine 580 and a presentation interface 590.

The user input interface 510 is adapted to receive a user formulated question Q_{U} on a natural language format, for instance in the form of a text entered via a keyboard or a spoken phrase entered via a microphone. The transforming module 520 is adapted to receive the user formulated question Q_{U} and convert it into a question template format Q_{UT}, which includes at least one user-specified entity term indicative of a respective main concept embodied in the user formulated question Q_{U}. The transforming module 520 is also adapted to convert the user-formulated question Q_{U} into a format Q_{UD} being suitable for matching against data instances Dᵢ in the structured database 570.

The central processing unit 530 orders data instance matching engine 560 to perform such a data instance matching on basis of this data-instance-matching formatted user question Q_{UD}. As a result, at least one matching data instance Dᵢ is identified and returned to the central processing unit 530.

Based on an instruction from the central processing unit 530, the template matching engine 550 matches the question-template formatted version of the user question Q_{UT} against the lexicon database 540 to retrieve a matching template cluster C_{TQ}^{m} containing at least one matching question template. The at least one matching question template in the matching template cluster C_{TQ}^{m} may have at least one entity slot, which is linked to the structured database 570. If none of the question templates in the matching template cluster C_{TQ}^{m} has any entity slots, this means that the question templates in C_{TQ}^{m} are static, such as FAQS. In this case, a relevant answer is be generated in the form of a static text.

The matching template cluster C_{TQ}^{m} is also associated with a matching query template T_{Y}^{m} and a matching answer template (α_{T}^{m}. The matching template cluster C_{TQ}^{m} is returned to the central processing unit 530 (along with the matching query template T_{Y}^{m}. and the matching answer template α_{T}^{m}).

Provided that the at least one matching question template in the matching template cluster C_{TQ}^{m} has at least one entity slot, the central processing unit 530 fills at least one particular entity slot of the at least one matching question template in the matching template cluster C_{TQ}^{m} with the identified at least one matching data instance Dᵢ, and preferably all the entity slots of this matching question template are thus filled with the relevant data instances Dᵢ.

Again, provided that the at least one matching question template in the matching template cluster C_{TQ}^{m} has at least one entity slot, the central processing unit 530 forwards the matching query template T_{Y}^{m} to the search engine 580. Based thereon, the search engine 580 queries the structured database 570, and as a result, information [i] is obtained, which is required to complete the matching answer template α_{T}^{m} that is linked to the matching template cluster C_{TQ}^{m}.

The central processing unit 530 then completes the matching answer template α_{T}^{m}, and produces a corresponding answer a. The answer a is finally transferred to the presentation interface 590 to be presented on a format au suitable for perception by a user, e.g. graphically or acoustically.

Preferably, two or more of the engines 550, 560 and 580 are combined in one module, where they share common resources. It is particularly advantageous to thus combine the template matching engine 550 and the data instance-matching engine 560.

In order to sum up, the general method for processing textual information according to the invention will now be described with reference to a flow diagram in FIG. 6. A first step 610 checks whether a user-formulated question has been received, and if so, the procedure continues in parallel to steps 620 and 630 respectively. Otherwise, the procedure loops back and stays in the step 610. The step 620 transforms the received user formulated question into a data instance-matching format, which is adapted to match data instances. The step 630 transforms the received user formulated question into a question template format including at least one entity term, which each is indicative of a respective main concept embodied in the user formulated question.

Following the step 630, a step 650 matches the question-template formatted user question against a lexicon database to obtain at least one matching question template. As mentioned above with reference to FIG. 5, the at least one matching question template may or may not have one or more one entity slots. In case the matching question template has at least one entity slot, this is linked to the structured database that represents at least a part of the conceptual model of the knowledge domain.

Moreover, each of the at least one matching question template is presumed to belong to a particular matching template cluster and is associated with an answer template. Provided that the at least one matching question template has at least one entity slot, it is also associated with a query template. The lexicon database, in turn, is presumed to contain a multitude of concepts which each is related to a specific question template. In any case, question templates that are semantically close to the user formulated question and reference the same concepts/entities from the conceptual model of the structured database as the user formulated question are retrieved in this step.

A step 640 subsequent to the step 620, matches the data-instance-matching formatted user question against the structured database to identify at least one matching data instance to fill at least one particular entity slot of the at least one matching question template in the matching template cluster. The step 640 assumes that there exists at least one matching template cluster whose question templates have at least one entity slot. A subsequent step 655 (see below), handles the case when none of the question templates in the matching template cluster has any entity slots.

Consequently, in the steps 620-650, the system identifies which data instances (residing in the structured database, and their corresponding concepts/entities) that are referenced in the user-formulated question. By data instance is here understood a short piece of information which identifies a real world object, such as the name of a person or a place, the title of an event etc. The steps 620, 640 and 630, 650 respectively may either be performed in parallel (as indicated in the FIG. 6) or be executed in series, where the step 620 precedes the step 640 and the step 630 precedes to the step 650.

After completion of the steps 640 and 650, the step 655 checks whether at least one matching template in the matching template cluster has at least one entity slot. If this is the case, a step 660 follows. Otherwise, the procedure continues by presenting a relevant answer to the user-formulated in the form of a static text, e.g. an FAQ-answer. A reference sign “A” in the FIG. 6 represents this.

If the check in the step 655 finds that the matching template cluster contains at least one matching template, which has at least one entity slot, a step 660 queries the structured database with the query template, associated with the matching template cluster, to obtain information required to fill the matching answer template associated with the matching template cluster. Finally, a step 670 presents a resulting answer (e.g. via a display or an acoustic interface) on a format suitable for perception by a human user.

According to a preferred embodiment of the invention, the process does not proceed directly from the step 655 to the step 660. Instead, after the checking-step 655, a step 656 follows in which the at least one matching question template in the matching template cluster is presented on a format adapted to be perceived by a human user. Each of the at least one matching question template is filled with the at least one relevant matching data instance in at least one particular entity slot. Then, a step 657 checks whether a user selection command has been received in respect of one particular matching question template, and if so, the procedure continues to the step 660 where the thus selected matching question template is regarded as representing a preferred interpretation of the user formulated question on which the answer in the step 670 exclusively is based. Otherwise, the procedure loops back and stays in the step 657.

All of the process steps, as well as any sub-sequence of steps, described with reference to the FIG. 6 above may be controlled by means of a programmed computer apparatus. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The carrier may be any entity or device capable of carrying the program. For example, the carrier may comprise a storage medium, such as a ROM (Read Only Memory), for example a CD (Compact Disc) or a semiconductor ROM, or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. A method of processing textual information to automatically answer user-submitted questions pertaining to a knowledge domain, comprising the steps of:
receiving a user formulated question on a natural language format,
representing the user formulated question on a question template format including at least one entity term indicative of a respective main concept embodied in the user-formulated question,
representing the user formulated question on a data instance-matching format adapted to query a structured database,
template matching the question-template formatted user formulated question against a lexicon database to retrieve a matching template cluster including at least one matching question template, the lexicon database containing a multitude of concepts which each is related to a specific question template,
testing if at least one of the at least one matching question template includes at least one entity slot which is linked to a structured database representing at least a part of a conceptual model of the knowledge domain, the matching template cluster being associated with a matching query template and an answer template, and if so
data instance matching the data instance-matching formatted user formulated question against the structured database to identify at least one matching data instance to fill at least one particular entity slot of the at least one matching question template,
querying the structured database with the matching query template to obtain information completing the matching answer template, and
presenting an answer to be perceived by a user, the answer being based on the retrieved information and the matching answer template.

2. A method according to claim 1, wherein if none of the at least one matching question template includes any entity slots, comprising the step of:
presenting an answer to be perceived by a user, the answer being based on static data in a matching answer template being associated with the at least one matching question template.

3. A method according to claim 1, wherein before the querying step, comprising the steps of:
presenting the at least one matching question template filled with at least one matching data instance in at least one particular entity slot to be perceived by a user, and
receiving a user selection command in respect of one particular matching question template to represent a preferred interpretation of the user formulated question.

4. A method according to claim 3, wherein producing the answer exclusively on basis of the preferred interpretation of the user formulated question.

5. A method according to claim 1, wherein the lexicon database is a multiple-lexicon database containing at least one autonomous unit, and each autonomous unit represents at least one concept related to one question template.

6. A method according to claim 1, wherein the data instance matching process involving searching in an index over data instances to produce a reduced set of candidate data instances.

7. A method according to claim 1, wherein the data instance matching process involving an entity-specific matching of matching data instances belonging to at least one concept/entity.

8. A method according to claim 1, wherein the data instance matching process involving a data-instance-specific matching of matching alternative representations of data instances.

9. A computer program product directly loadable into the internal memory of a computer, comprising software for controlling the steps of claim 1 when said program product is run on the computer.

10. A computer readable medium, having a program recorded thereon, where the program is to make a computer control the steps of claim 1.

11. A textual information processing system for automatically answering user-submitted questions pertaining to a knowledge domain, comprising:
a user input interface adapted to receive a user-formulated question on a natural language format,
a transforming module adapted to:
convert the user formulated question into a question template format including at least one entity term indicative of a respective main concept embodied in the user formulated question, and
convert the user-formulated question into a data instance-matching format adapted to match data instances,
a lexicon database containing a multitude of concepts which each is related to a specific question template,
a structured database representing at least a part of conceptual model of the knowledge domain,
a template matching engine adapted to match the question-template formatted user formulated question against the lexicon database to retrieve a matching template cluster including at least one matching question template, the at least one matching question template having at least one entity slot which is linked to the structured database, the matching template cluster being associated with a matching query template and an answer template.
a data instance-matching engine adapted to match the data instance-matching formatted user formulated question against the structured database to identify at least one matching data instance,
a central processing unit adapted to fill at least one particular entity slot of the at least one matching question template with the identified at least one matching data instance,
a search engine adapted to query the structured database with the matching query template to retrieve information to complete the matching answer template, and
a presentation interface adapted to present an answer to be perceived by a user, the answer being based on the retrieved information and the matching answer template.

12. A textual information processing system according to claim 11, wherein before triggering the search engine to query the structured database:
the presentation interface is adapted to present the at least one matching question template to be perceived by a user, and
the user input interface is adapted to receive a user selection command in respect of one particular matching question template and the at least one matching data instance to represent a preferred interpretation of the user formulated question.

13. A textual information processing system according to claim 12, comprising a central processing unit adapted to produce the answer exclusively on basis of the preferred interpretation of the user submitted question.

14. A textual information processing system according to claim 11, wherein the lexicon database is a multiple-lexicon database containing at least one autonomous unit, and each autonomous unit represents at least one concept related to one question template.

15. A textual information processing system according to claim 11, wherein the data instance matching engine is adapted to search an index over data instances to produce a reduced set of candidate data instances.

16. A textual information processing system according to claim 11, wherein the data instance matching engine is adapted to perform an entity-specific matching of matching data instances belonging to at least one concept/entity.

17. A textual information processing system according to claim 11, wherein the data instance-matching engine is adapted to perform a data-instance-specific matching of alternative representations of data instances.
